(19) United States
(12) Patent Application Publication
(10) Pub. No.: US 2016/0107574 A1
(43) Pub. Date: Apr. 21, 2016

(54) CONTROL UNIT FOR A MOTOR VEHICLE HAVING A CAMERA FOR THE DRIVER'S FACE, AND METHOD FOR IMAGING THE FACE OF A VEHICLE OCCUPANT

(71) Applicant: Robert Bosch GmbH, Stuttgart (DE)

(72) Inventors: Andreas Voelkel, Ispringen (DE); Ruediger-Walter Henn, Weil Der Stadt (DE); Ester-Sabrina Wacker, Hildesheim (DE); Alexander Mueller, Bietigheim (DE); Philippe Dreuw, Heersum (DE)

(21) Appl. No.: 14/884,971

(22) Filed: Oct. 16, 2015

(30) Foreign Application Priority Data
Oct. 16, 2014 (DE) 10 2014 221 039.9

(51) Int. Cl. B60R 1/00; H04N 5/232; H04N 7/18

(52) U.S. Cl. CPC B60R 1/00; H04N 7/183; H04N 5/23219; B60R 2300/8006

(57) ABSTRACT

In a method for detecting the face of a driver of a motor vehicle having a camera, in order to ensure that an unfavorable posture of the driver or an unfavorable position of the steering wheel or of the driver's seat of the motor vehicle does not prevent recognition of the face using the camera, provision is made that a positioning signal for the steering wheel, for the driver's seat, or for a pedal is generated if the face is not detectable in the image data.

### BACKGROUND OF THE INVENTION

1. Field of the Invention

The present invention relates to a control unit for a motor vehicle having a camera for imaging the face of an occupant of the motor vehicle, and further relates to a method for imaging the face of an occupant of a motor vehicle, in which image data of the occupant are generated.

2. Description of the Related Art

In modern motor vehicles, image data of the driver are generated in order to ascertain whether the driver is capable of driving the motor vehicle or whether the driver is no longer capable of doing so, for example due to fatigue. The position of the driver's seat, as well as other operating or safety elements of the motor vehicle, can furthermore be optimally predefined or adjusted for the driver based on driver position data derived from the image data, as disclosed in published German patent application document DE 10 2007 023 141 A1. The driver's face is often imaged for this purpose using the camera.

Because the vehicle can be controlled by drivers of different heights, the risk exists that the face will not be detected, or will be insufficiently detected, in the image data generated with the camera. With particularly tall drivers, for example, the camera may image only a portion of the upper body or only a lower part of the face, so that driver fatigue cannot be identified. In addition, the driver's face can be concealed from the camera's view by the steering wheel of the motor vehicle. It is consequently not possible to ascertain reliably whether the motor vehicle can be safely controlled by the driver, since fatigue states, in particular, of the driver cannot be reliably detected.

### BRIEF SUMMARY OF THE INVENTION

The present invention makes available a control unit of the kind recited above, the control unit being embodied to output a positioning signal for an apparatus of the motor vehicle, said apparatus influencing the imageability of the face, when at least a predefined portion of the face is not detectably contained in image data capable of representing the acquired image. The present invention furthermore makes available a method of the kind recited above in which a positioning signal for an apparatus of the motor vehicle, said apparatus influencing the imageability of the face, is generated if at least a predefined portion of the face is not detectably contained in the image data.

The apparatus influencing the imageability of the face can then be adjusted, based on the positioning signal, in such a way that at least the predefined portion or even the entire face is detectably contained in the image data. Sleepiness on the part of the occupants, and in particular of the driver, can thus be reliably monitored and/or the driver's seat and/or other operating or safety elements can be ergonomically placed.

The approach according to the present invention can be further improved by way of a variety of embodiments that are individually advantageous and, unless otherwise indicated, can be combined in any way with one another. These embodiments and the advantages associated with them will be discussed below.

For example, based on the positioning signal the driver's head can be brought into a positional region (“head box”) that can be optimally sensed by the camera (acceptance angle, depth of field, ambient lighting). Alternatively or additionally, the positional region (“head box”) that can be optimally sensed by the camera can be disposed, by moving the camera, in such a way that the driver's head can be detectably imaged. In some circumstances (e.g. with very short people) it can be necessary to adapt and adjust at least one pedal, or all pedals, of the pedal apparatus of the motor vehicle to this optimum seat position, so that the driver can actuate the pedals without limitation. Positioning of the steering wheel can then ensure that the face, or the relevant facial features, of the driver can be sensed by the camera without being concealed by the steering wheel or by his or her hands on the steering wheel. The positioning signal is thus generated in order to improve safety.

The apparatus can be, for example, the steering wheel or a seat, in particular the driver's seat, of the motor vehicle. For example, the steering wheel, the driver's seat, and/or a pedal of the motor vehicle can be positioned on the basis of the positioning signal in such a way that the face is imageable with the camera, while the driver can assume an ergonomic seated position. The result is to ensure, in addition to monitoring for sleepiness, that driver fatigue due to a disadvantageous seat position, for example, is prevented, and that driver fatigue can be identified, so that the motor vehicle can be driven more safely.

The control unit can furthermore be embodied to terminate output of the positioning signal when at least the predefined portion of the face, or even the entire face, has been detected in the image data. The positioning signal can thus be generated or outputted until at least the predefined portion of the face, or even the entire face, has been detected in the image data. Premature shutoff of the positioning signal is thus avoided, and the positioning signal is also not outputted for an unnecessarily long time. The driver of the vehicle, to whom the positioning signal is possibly displayed, thus knows immediately when his or her face has been detected in the image data. His or her face can have been at least partly, or entirely, detected in the image data. Especially when the intention is only to monitor fatigue states of the driver, it can be sufficient to detect only the driver's eyes in the image data. Consequently, at least the eyes, or another portion of the face, or even the entire face, are to be imaged by the camera.

The control unit can furthermore be embodied to detect, on the basis of the available image data of the driver, the direction and optionally also the extent of the positioning necessary for detecting the face or the part of the face, and to generate and/or output the positioning signal accordingly.

The motor vehicle can have a display for depicting a positioning of the apparatus and/or of the pedals which is necessary for finding the face. The positioning signal that can be furnished by the control unit during operation can be deliverable, for example, representatively for the direction of the positioning necessary for detection of the face or of the part of the face, and optionally also representatively for the extent of the necessary positioning, and more, to the display. The display can define, based on the positioning signal, the direction in which the steering wheel, the driver's seat, and/or the pedal are to be positioned. For example, the steering wheel can be moved upward or downward, by pivoting a steering column on which the steering wheel is installed, in order to image the driver's face detectably with the camera and allow it to be converted into image data generated by the camera. The position of the steering wheel and/or of the driver's seat can thus be adjusted at least in part manually in such a way that the driver's face can be found. The positioning signal is thus, for example, a control signal for applying control to the display of the motor vehicle in order to display a modification, necessary for detectable imaging of the face, in the position or adjustment of the apparatus.

If the motor vehicle has at least one electrical adjusting device for the apparatus, i.e. for example for the steering wheel, the driver's seat, and/or the pedal, with which the position of the apparatus can be influenced, the positioning signal can be a control setting for the adjusting device. The apparatus can then be positioned at least partly or even entirely automatically, until the face or the predefined facial portion is sufficiently identifiable in the image data generated by the camera and/or the driver can assume an ergonomic sitting position.

In particular, the positioning signal can be outputtable through at least a, or a further, signal output of the control unit to different destinations and, for example, can be directed to the at least one display and/or to the at least one adjusting device if the control unit is installed in the motor vehicle. If a position of the apparatus, in particular of the steering wheel and/or of the seat, which is modified by the adjusting device is not sufficient to allow reliable detection of the face, the position of the apparatus, in particular of the steering wheel and/or of the seat, can be adjustable not only automatically or in motorized fashion but additionally also manually.

The positioning signal can be outputted, and consequently the apparatus, for example the steering wheel and/or seat, can be positioned manually and/or automatically, until the face has been detected. During positioning, further image data can be generated and at least the predefined face portion, or the entire face, can be searched for in the image data. For example, individual images or a continuous moving-image sequence can be generated, and the face or the desired part of the face can be searched for therein in order to ascertain reliably, during positioning, whether or when the face is detectably contained in the image data generated by the camera. The image input can thus be embodied to accept image data representing multiple successive individual images and/or a moving image sequence.

For example, the predefined portion or the entire face can be searched for in the image data after the driver has seated him- or herself in the driver's seat and/or before the vehicle has been started and/or directly after the vehicle has been started. The control unit can have for this purpose a triggering input to which a triggering signal or starting signal is deliverable from the motor vehicle. The triggering signal or starting signal represents, for example, the fact that the driver is sitting in the driver's seat or has fastened his or her seatbelt. Once the triggering signal or starting signal is present at the triggering input, the control unit waits for image data at the image data input, in which data it attempts to detect the face. Imaging of the driver and detection of his or her face can thus begin once the driver has fastened his or her seatbelt, since once the seatbelt is fastened it can be assumed that the driver has taken up a sitting position sufficient for driving.

Because the driver can modify his or her sitting position while driving, the positioning signal can be generated and/or outputted again if at least the predefined portion, or even the entire face, of the driver is no longer detectably contained in the image data. Automatic positioning of the steering wheel by the adjusting device can, in particular, also be performed while driving.

The camera is disposed, for example, on the steering column, so that the camera can be moved together with the steering wheel as the steering column is pivoted and can be directed toward the driver's face. For aesthetic reasons, however, and because a visible camera directed at the driver is often perceived as annoying, the camera is preferably disposed in a display of the motor vehicle. The display can be disposed in the instrument panel, i.e. behind the steering wheel from the driver's point of view and in the driving direction. The display is, for example, a multifunction display disposed in a driver information region, an in particular a display screen; the camera can be integrated into the display in a manner that is invisible to the driver.

The predefined portion of the face can be a part of the face, for example the eye portion, that permits an inference as to the sleepiness of the occupant or as to the ergonomic adjustment of the operating and/or safety elements of the motor vehicle. Alternatively, the predefined portion can encompass the entire face.

If the predefined portion of the entire face is detectably contained in the image data, this means that features of the face can be detected by the control unit in such a way that an inference is possible as to the sleepiness of the occupant or as to the ergonomic adjustment of the operating and/or safety elements of the motor vehicle. If the predefined portion or the entire face is not detectably contained in the image data, this means that features of the face cannot be detected by the control unit in such a way that an inference as to the sleepiness of the occupant, or as to the ergonomic adjustment of the operating and/or safety elements of the motor vehicle, is possible. For example, the predefined portion or the face may not be disposed, or may be only insufficiently disposed, in a viewing region of the camera, or may be concealed by the apparatus, for example the steering wheel. The face may furthermore be disposed in front of or behind the field of view of the camera from the camera's point of view, and consequently may not be imageable with sufficient sharpness by the camera.

### BRIEF DESCRIPTION OF THE DRAWINGS

FIG. 1 schematically depicts an exemplifying embodiment of a control unit according to the present invention in a motor vehicle.

FIG. 2 schematically depicts an exemplifying embodiment of a method according to the present invention.

### DETAILED DESCRIPTION OF THE DRAWINGS

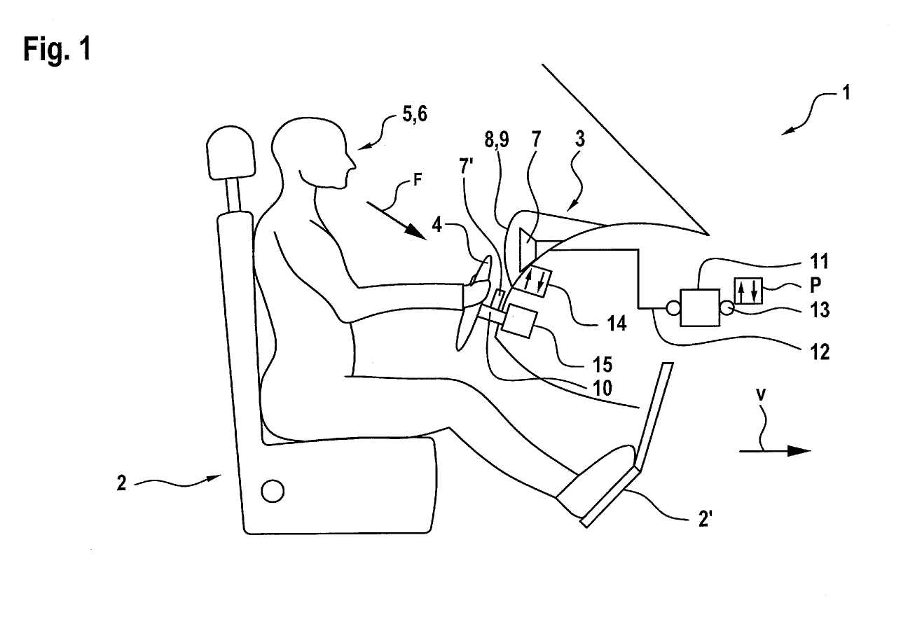

The construction and function of a control unit according to the present invention installed in a motor vehicle will first be described with reference to the exemplifying embodiment of FIG. 1. FIG. 1 is a schematic side view showing a part of motor vehicle 1, having a driver's seat 2, a pedal 2′, an instrument panel 3, and a steering wheel 4.

Motor vehicle 1 has a camera 7 in order to allow imaging of face 5 of a driver 6 sitting in driver's seat 2. In the exemplifying embodiment of FIG. 1, camera 7 is disposed behind a cover panel 8 of a display 9, provided in a driver information region F, of motor vehicle 1, so that driver 6 cannot readily see camera 7. Display 9 is, for example, a multifunction display with which a speedometer can be presented. Alternatively, the camera can be disposed on a steering column 10 on which steering wheel 4 is mounted. In the exemplifying embodiment of FIG. 1, the camera alternatively disposed on steering column 10 is labeled with the reference character 7′.

Motor vehicle 1 furthermore has a control unit 11 that is connected, for example, via a data lead 12 to camera 7, 7′ in an image data-receiving manner. In the interest of clarity, only the exemplifying embodiment in which data lead 12 connects camera 7 to control unit 11 is depicted in FIG. 1.

A positioning signal P, for an apparatus that potentially influences, and can even impair or prevent, the imageability of the portion of the face or even of the entire face, can be outputted at a signal output 13 of control unit 11 during the operation of motor vehicle 1. For example, the positioning signal P can be generated and outputted for steering wheel 4 if, for example, steering wheel 4 is to be positioned in order to find face 5. Signal output 13 can be connected in signal-conveying fashion to a display 14 and/or to an electrical adjusting device 15. Display 14 can indicate to driver 6, during operation, whether and in which direction the apparatus, i.e. for example steering wheel 4, is to be positioned so that camera 7, 7′ can image face 5 of driver 6.

The position of the apparatus, for example steering wheel 4, can be electrically driven and, in particular, automatically modified using adjusting device 15. During electrically driven modification of the position of the apparatus, the display can optionally display the position modification.

Alternatively or additionally, the or at least one further positioning signal P can be conveyed to a positioning actuator of driver's seat 2 and/or to an actuator of pedal 2′ in order to position driver's seat 2 and/or pedal 2′ in motorized fashion. The or at least one further positioning signal P can also be delivered to the or to a further display 14 in order to display a detection-enabling modification, in the position of steering wheel 4, of seat 2, or of pedal 2′.

In order to check whether camera 7, 7′ can at least partly or even entirely image face 5 of driver 6, camera 7, 7′ can send image data to control unit 11 or to a face detection device. Using control unit 11 or the face detection device, a determination is made as to whether face 5 is detectably contained in the received image data. If face 5 is not contained detectably, or at all, in the received image data, control unit 11 generates the positioning signal P and outputs it via the at least one signal output 13, for example, to display 14 and/or to adjusting device 15.

Steering wheel 4 can, with steering column 10, be manually and/or automatically positioned and, for example, pivoted using adjusting device 15. Steering wheel 4 is disposed, for example, between camera 7, 7′ and driver 6 in a forward direction V of vehicle 1. Camera 7, 7′ can in particular be provided behind steering wheel 4 in the forward direction V.

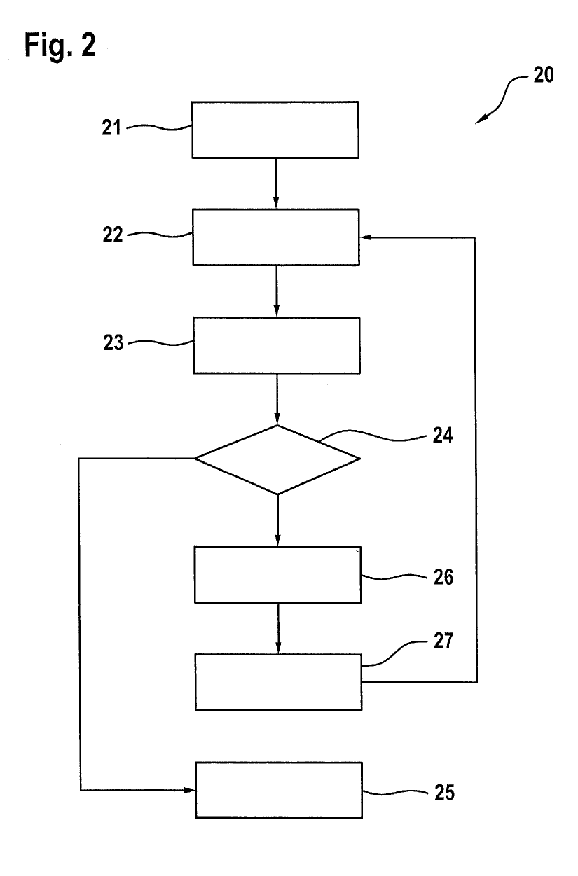

FIG. 2 schematically shows an exemplifying embodiment of the method according to the present invention as a flow chart. The same reference characters used for elements of the exemplifying embodiment of FIG. 1 are used below in order to describe the exemplifying embodiment of FIG. 2.

FIG. 2 shows method 20 schematically as a flow chart. Method 20 starts with a method step 21. In method step 21, for example, motor vehicle 1 is started. Alternatively, method step 21 can detect the fact that driver 6 has seated him- or herself in driver's seat 2. It is also possible to detect whether driver 6 has fastened his or her seatbelt. In method step 22 that now follows, an image of driver 6 is acquired using camera 7, 7′, and image data are generated from the image.

In order to detect whether camera 7, 7′ can detectably image face 5 or the predefined portion, in method step 23 face 5 or the predefined portion is searched for in the image data, and an attempt is made to detect face 5 or the predefined portion. In method step 24 that follows method step 23, an assessment is made as to whether face 5 or the predefined portion is contained, or has been detected, at all or at least sufficiently in the image data. If face 5 or the predefined portion was detected in the image data, method step 24 can be followed by method step 25, in which method 20 ends. Method 20 can be following by an operation of monitoring driver 6, which investigates, for example, whether driver 6 is tired or in fact fatigued.

If face 5 or the predefined portion was not detected in the image data, method step 24 can be followed by method step 26, in which the positioning signal P is generated or outputted. In method step 27 that now follows, at least the apparatus, i.e. for example steering wheel 4 and/or seat 2, and/or pedal 2′, is positioned. During or subsequently to method step 27, method step 22 can be carried out again. At least one further image, or an image sequence, can consequently be acquired after or during positioning. Face 5 of driver 6, or the predefined portion, can be searched for in the image or in the images of the image sequence. As soon as face 5 of driver 6, or the predefined portion, has been detected in the image data of the image or of the image sequence, positioning signal P can be stopped in method step 25. If face 5 or the predefined portion is no longer detected in the image data of the image or of the image sequence, positioning signal P can be outputted again.

What is claimed is:

1. A control unit for a motor vehicle having a camera for imaging a face of an occupant of the motor vehicle, the control unit comprising:
a controller including a processor configured to output a positioning signal for an apparatus of the motor vehicle when at least a predefined portion of the face is not detectably contained in image data of acquired image, said apparatus influencing the imageability of the face.

2. The control unit as recited in claim 1, wherein the controller is configured to terminate output of the positioning signal when at least the predefined portion of the face has been detected in the image data.

3. The control unit as recited in claim 2, wherein the positioning signal is a control signal for applying control to a display of the motor vehicle in order to display a modification in the position of the apparatus necessary for detectable imaging of the face.

4. The control unit as recited in claim 2, wherein the positioning signal is a control setting for applying control to an electrical adjusting device for the apparatus.

5. A method for imaging a face of an occupant of a motor vehicle, comprising:
generating, using a camera of the motor vehicle, image data of the occupant; and
generating, using a controller including a processor, a positioning signal for an apparatus of the motor vehicle, if at least a predefined portion of the face is not detectably contained in the image data, said apparatus influencing the imageability of the face.

6. The method as recited in claim 5, wherein the positioning signal is generated until at least the predefined portion of the face has been detected.

7. The method as recited in claim 6, wherein the position of the apparatus is modified until at least the predefined portion of the face has been detected.

8. The method as recited in claim 7, wherein further image data are generated during the modification of the position, and the predefined portion of the face is searched for in the generated image data.

9. The method as recited in claim 5, wherein the search for the predefined portion of the face in the image data is started at least one of (i) after the driver is seated in the driver's seat, and (ii) before the motor vehicle is started.

10. The method as recited in claim 5, wherein the positioning signal is outputted again if at least the predefined portion of the face is no longer detectably contained in the image data.
